(19) United States
(12) Patent Application Publication
(10) Pub. No.: US 2015/0362459 A1
(43) Pub. Date: Dec. 17, 2015

(54) Method and System for Concentrating Particles from a Solution

(71) Applicant: University of Washington through its Center for Commercialization, Seattle, WA (US)

(72) Inventors: Jae-hyun Chung, Bellevue, WA (US); Kyong-hoon Lee, Redmond, WA (US)

(21) Appl. No.: 14/379,163

(22) PCT Filed: Feb. 25, 2013
(86) PCT No.: PCT/US2013/027683

§ 371 Date: Aug. 15, 2014

Related U.S. Application Data
(60) Provisional application No. 61/756,741, filed on Jan. 25, 2013.
(60) Provisional application No. 61/603,163, filed on Feb. 24, 2012.

(51) Int. Cl. G01N 27/447

(52) U.S. Cl. CPC G01N 27/44756

(57) ABSTRACT

Methods and systems are provided for concentrating particles (e.g., bacteria, viruses, cells, and nucleic acids) suspended in a liquid. Vibration of a well containing the liquid may create a convective flow within the liquid to move the particles towards a electrode immersed in the liquid. Electric-field-induced forces attract the particles towards the electrode. When the particles are in close proximity to (e.g., in contact with) the electrode, an electrostatic force may immobilize the particles on a surface of the electrode, such that the particles remain on the surface of the electrode when the electrode is withdrawn from the liquid. Different coatings may further be applied to the electrode to achieve different particle attraction and immobilization characteristics.

### CROSS-REFERENCE TO RELATED APPLICATION

This application claims the benefit of U.S. Provisional Application No. 61/756,741, filed Jan. 25, 2013; and U.S. Provisional Application No. 61/603,163, filed Feb. 24, 2012; each of which is incorporated herein by reference in its entirety.

### STATEMENT OF GOVERNMENT LICENSE RIGHTS

This subject matter of the present application was made possible with U.S. government support under grant number 0956876, awarded by the NSF STTR II; under grant number ECCS-0846454, awarded by the NSF Career Award; and under grant number NIH/NIGMS 1R43GM099347, awarded by the NIH SBIR. The U.S. Government has certain rights in the invention.

### BACKGROUND

There are uses for alternate methods to extract human genomic DNA from body samples. DNA extraction may be used for medical, forensic, environmental, or military purposes. Popular sources may include saliva- and buccal swab samples because the sample collection is minimally invasive.

For DNA extraction, solid phase extraction (SPE) methods using porous silica are available. Cell lysates are infiltrated into silica micropores by high salt and chaotropic solutions, which may bind DNA by electrostatic charge. After washing with alcohol, the DNA is eluted in a low salt solution by electrostatic repulsion. The extraction yield may be high but multiple centrifuge steps may be required along with the use of toxic reagents. In the process, DNA may be degraded by alkaline solutions and flow-induced shear of DNA during centrifugation.

Preservation of DNA at room temperature may also be useful to medical, forensic, environmental, and military purposes. Preservation in aqueous solutions may be detrimental to DNA molecules and susceptible to chemical changes. Extended storage may require freezing or the use of specialized preservatives.

Some current methods for DNA extraction may be slow, inefficient, and expensive. As such, alternative methods for DNA extraction method may benefit global healthcare by offering increased efficiency, lower cost, and/or improved accuracy of tests for diseases such as cancer, among other examples.

### SUMMARY

In one aspect, a method is provided for concentrating a particle. The method involves immersing an electrode in a liquid comprising at least one particle. The liquid is contained within a well. The method further involves moving the at least one particle toward the electrode by vibrating the well such that a convective flow is created within the liquid, attracting the at least one particle toward the electrode by generating an electric-field-induced force using the electrode, immobilizing the at least one particle on a surface of the electrode with an electrostatic force, and withdrawing the electrode from the liquid.

In another aspect, a method for concentrating a particle is provided. The method involves immersing an electrode in a liquid comprising at least one particle. The liquid is contained within a well. The method further involves moving the at least one particle toward the electrode by vibrating the well such that a convective flow is created within the liquid, withdrawing the electrode from the liquid such that a capillary force formed between the electrode and the liquid immobilizes the at least one particle on a surface of the electrode.

In yet another aspect, a method for concentrating a particle is provided. The method involves immersing an electrode in a liquid comprising at least one particle. The electrode is at least partially coated with a positively charged coating. The method further involves attracting the at least one particle toward the electrode by generating an electric-field-induced force using the electrode, immobilizing the at least one particle on a surface of the electrode with an electrostatic force, and withdrawing the electrode from the liquid.

In yet another aspect, a particle concentrating system is provided. The particle concentrating system may include an electrode, a well containing liquid having at least one particle, a first actuator sized and configured to immerse and withdraw the electrode from the liquid, a second actuator sized and configured to vibrate the well such that a convective flow is created within the liquid, moving the at least one particle toward the electrode when the electrode is immersed, and an electric signal generator sized and configured to cause the electrode to produce an electric field to attract the at least one particle toward the electrode when the electrode is immersed in the liquid, and immobilize the at least one particle on a surface of the electrode when the electrode is withdrawn from the liquid.

In yet another aspect, a particle concentrating system is provided. The particle concentrating system includes an electrode, a well comprising liquid having at least one particle, a first actuator sized and configured to immerse and withdraw the electrode from the liquid such that a capillary force formed between the withdrawing electrode and the liquid immobilizes the at least one particle on a surface of the electrode, and a second actuator sized and configured to vibrate the well such that a convective flow is created within the liquid, moving the at least one particle toward the electrode when the electrode is immersed.

In yet another aspect, a particle concentrating system is provided. The particle concentrating system includes an electrode at least partially coated with a positively charged coating, a well comprising liquid having at least one particle, an actuator sized and configured to immerse and withdraw the electrode from the liquid, and an electric signal generator sized and configured to cause the electrode to produce an electric field to attract the at least one particle toward the electrode when the electrode is immersed in the liquid, and immobilize the at least one particle on a surface of the electrode when the electrode is withdrawn from the liquid.

### DESCRIPTION OF THE DRAWINGS

FIG. 1 is an example flow diagram illustrating a first method for concentrating particles from a solution;

FIG. 2A is a diagrammatic illustration of a portion of a representative embodiment, including the substantially linear movement of particles in a liquid towards an electrode by an electric-field-induced dielectrophoretic force generated by the electrode;

FIG. 2B is a diagrammatic illustration of a portion of the representative embodiment of the invention illustrated in FIG. 2A, wherein the electrode is retracted from the liquid and has particles concentrated on its surface as a result of capillary forces immobilizing particles from the liquid that were attracted to the electrode through electric-field-induced dielectrophoretic forces;

FIG. 3 is a diagrammatic illustration of a portion of a representative embodiment of the invention, including the circulating movement of particles in a liquid towards an electrode by an electric-field-induced electroosmotic force;

FIG. 4 is a diagrammatic illustration of a portion of a representative embodiment of the invention, including the combination of dielectrophoretic and electroosmotic forces on particles in a liquid attracting the particles towards an electrode comprising first binding partners capable of binding to second binding partners attached to the particles;

FIG. 5A is an example flow diagram illustrating a second method for concentrating particles from a solution;

FIG. 5B is an example flow diagram illustrating a third method for concentrating particles from a solution;

FIG. 6A-D shows an example portable microtip device for DNA extraction;

FIG. 7 shows an example protocol for cell lysis, DNA capture, and elution for buccal swab and saliva samples;

FIGS. 8A-B shows an example PCR analysis for buccal swab samples;

FIGS. 9A-C show an example PCR analysis of human genomic DNA from saliva samples;

FIG. 10 shows an example comparison between the microtip device and the commercial kit for saliva samples;

FIGS. 11A-C shows an example scalability of microchips;

FIG. 12 shows a schematic of a microtip array in an aluminum well;

FIGS. 13A-D shows example trajectories of a 3 μm diameter sphere near the microtip according to EP, DEP, and EOF;

FIGS. 14A-B shows example digitized fluorescence signals of captured DNA on non-coated microtips;

FIGS. 15A-B shows example fluorescence signals upon various frequencies of AC and biased AC fields for non-coated microtips;

FIG. 16 shows example immersion time tests of AC and biased AC fields for non-coated microtips;

FIG. 17 shows example immersion time tests of PLL-coated microtips for 10 MHz AC and 10 MHz biased AC fields;

FIGS. 18A-D shows fluorescence signal images of non-coated and PLL-coated microtips after capture of λ-DNA at immersion time of four minutes;

FIG. 19 shows example reproducibility tests for AC and biased AC fields using PLL-coated microtips; and

FIG. 20 shows an example of ten consecutive captures using PLL-coated microtips from a single well containing λ-DNA.

### DETAILED DESCRIPTION

The particulars shown herein are by way of example and for purposes of illustrative discussion of embodiments of the present invention only and are presented in the cause of providing what is believed to be a useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3^{rd} Edition or a dictionary known to those of skill in the art, such as the Oxford Dictionary of Biochemistry and Molecular Biology (Ed. Anthony Smith, Oxford University Press, Oxford, 2004).

As used herein and unless otherwise indicated, the terms “a” and “an” are taken to mean “one”, “at least one” or “one or more”. Unless otherwise required by context, singular terms used herein shall include pluralities and plural terms shall include the singular.

### Example Methods and Systems for Concentrating Particles in a Liquid

Methods and systems for concentrating particles (e.g., bacteria, viruses, cells, and nucleic acids) in a liquid are provided. Electric-field-induced forces may be utilized to attract the particles towards an electrode immersed in the liquid. In one example, when the particles are in close proximity to (e.g., in contact with) the electrode, the electrode may be withdrawn from the liquid and capillary forces formed between the withdrawing electrode and the surface of the liquid may immobilize the particles on the electrode. In another example, the electric-field-induced forces may include an electrostatic force that may immobilize the particles on the surface of the electrode when the electrode is withdrawn. Other examples, as will be discussed below, are also possible.

In either case, upon withdrawal of the electrode from the liquid, particles may be immobilized on a portion of the electrode previously immersed in the liquid. Depending on the geometric shape of the electrode, the particles may be immobilized on the distal tip, the sides, or both. The particles on the surface of the electrode may be concentrated more densely on the electrode than in the solution, and thus analysis of the particles (e.g., by fluorescence spectroscopy) may be improved. Further, a well containing the liquid may be vibrated to generate a convective flow within the liquid to move more particles toward the electrode. As a result, a higher number of particles may come within close proximity to the electrode while the electrode is immersed, and a higher concentration of particles may be immobilized on the electrode when the electrode is withdrawn.

In another example, the electrode tip may be coated with different materials to help provide different particle-concentrating characteristics. In one case, a positively-charged coating may be used to help attract a more even distribution of different particles within the liquid. In another case, a biotin-recognition layer, such as a streptavidin coating may be used to help specifically attract particles conjugated with biotin. As such, different coatings may be used to achieve different particle-concentrating results.

In addition to concentrating particles for analysis, the concentrated particles may be further treated in accordance with various purposes. For example, the particles on the electrode may be stored for future use (e.g., with cryogenic freezing), or introduced into a second liquid (e.g., in situ introduction of the particles into a cell).

As will be described in further detail below, the methods and systems disclosed herein may provide means for analyzing biological fluids for a variety of medically relevant analytes, such as bacteria (e.g., tuberculosis), viruses (e.g., HIV), cells (e.g., drosophila cells), and nucleic acids (e.g., DNA and RNA), among other examples.

In one aspect, a method is provided for concentrating a particle. The method may involve immersing an electrode in a liquid comprising at least one particle. The liquid is contained within a well. The method further involves moving the at least one particle toward the electrode by vibrating the well such that a convective flow is created within the liquid, attracting the at least one particle toward the electrode by generating an electric-field-induced force using the electrode, immobilizing the at least one particle on a surface of the electrode with an electrostatic force, and withdrawing the electrode from the liquid.

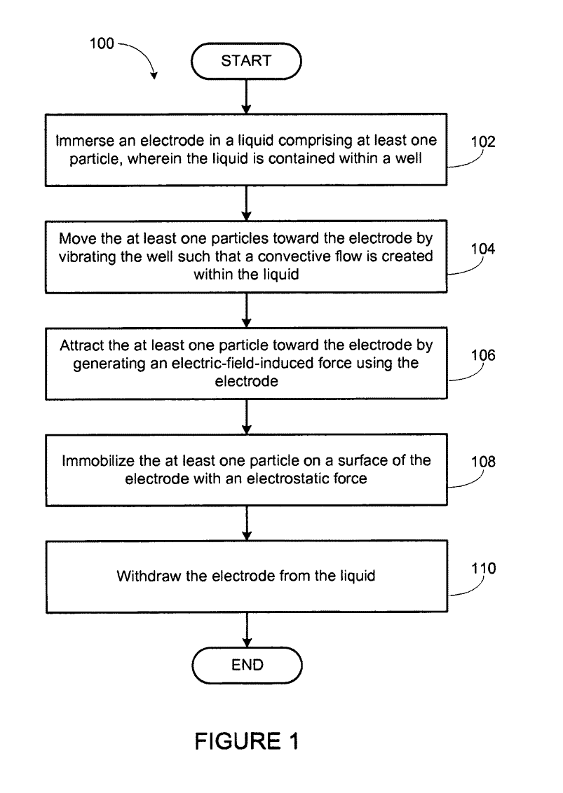

FIG. 1 shows an example method 100 for concentrating a particle, according to an embodiment of the present application. In one example, the method 100 may be executed by a system or device as will be described in the following. The method 100 may include one or more operations, functions, or actions as illustrated by one or more of blocks 102-110. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

At block 102, the method 100 may involve immersing an electrode in a liquid comprising at least one particle. In one example, the electrode may be made from an electrically conductive material such as a metal, a doped semiconductor, or a conductive polymer. Metal-coated insulators are also useful in the method, as long as a sufficient electric field can be generated with the electrode so as to generate an electric-field-induced force as described below.

As used herein, the term “aspect ratio” with reference to the electrode means the ratio of a diameter of the electrode (e.g., the distal tip diameter) to the length of electrode immersed in the liquid. If an electrode is conical, the average diameter of the electrode provides an estimate of the diameter of the electrode.

In one case, the electrode may have a high aspect ratio, so as to provide a relatively large surface area immersed within the liquid. For such an example high aspect ratio electrode, the diameter of the distal tip may be smaller than 1 mm and thus provides a relatively small area for generating a high-strength electric field during the method. For instance, the high aspect ratio of the electrode, in an exemplary embodiment, may provide a concentrated electric field sufficient to attract DNA to the electrode using DEP. In one embodiment, a high aspect ratio electrode may have a diameter-to-length ratio of from 1:1 to 1:100.

In one embodiment, the electrode may include a tip, wherein the tip of the electrode may be the distal end of the electrode and terminates in a single point. The electrode tip may be conical, rounded, or truncated. In one embodiment, the distal end may be truncated and has no tip terminating in a single point. In another embodiment, the electrode may include a branched dentrite structure comprising multiple distal ends. In this embodiment, some of the distal ends may terminate into respective single points.

The electrode may include a shaft having a shaft latitudinal dimension and a distal tip having a distal latitudinal dimension. For a conical tip, the distal latitudinal dimension may be smaller than the shaft latitudinal dimension. The latitudinal dimensions are equal for a cylindrical electrode with no tip.

The shape of the electrode can be modified to suit a particular application. The geometry of the tip may determine the position on the electrode where particles are preferentially immobilized through the method of the invention. For example, a cylindrical electrode having a truncated distal end will tend to concentrate particles on the sides of the cylinder as opposed to the truncated distal end of the cylinder. In another example, an electrode having a dentrite branch structure may provide greater surface area for concentrating particles, and for generating a greater electric-field-induced force.

The electrode may further be coated with different materials, such as a positively charged coating. In one example, the positively charged coating may be a poly-L-lysine (PLL) coating or a polyethyleneimine (PEI) coating. In another example, the electrode may include a precious-metal layer, such as gold, silver, or platinum layers. Other precious-metals may also be used, including, but not limited to palladium, and rhodium. In one case, precious-metal layer and the PLL or PEI coating may cause a more even distribution of particles in the liquid to be attracted to the electrode. In the case of a precious-metal layer, the captured particles may be less degraded by reactive chemical species, and may therefore cause a more even distribution of particles. PLL or PEI coatings may hold a particle via electrostatic interactions, and may therefore cause a more even distribution of particles.

In one case, a capillary force formed between the surface of the electrode and a surface of the liquid when withdrawing the electrode from the liquid may cause particles immobilized on the surface of the electrode to shift. In such a case, the electrode may be coated with a coating, such as the positively charged coating discussed above to reduce a capillary force when the electrode is withdrawn from the liquid. In such a case, the particles immobilized on the electrode may shift less during withdrawal of the electrode.

In one embodiment, the latitudinal dimension of the electrode may be less than 1 mm. In one embodiment, the latitudinal dimension of the electrode may greater than 1 nm. In one embodiment, the latitudinal dimension of the electrode may be from 1 nm to 1 mm. Further, particular electrode shapes, such as conical electrodes, have varying latitudinal dimensions and the range of dimensions of this embodiment refers to the smallest measured latitudinal dimension, i.e., the distal tip of the electrode. The terms “nanotip” and “microtip” are used herein to describe an electrode having a diameter less than about one micron and greater than about one micron, respectively.

In one example, the liquid may be contained within a well, and may contain a plurality of particles. The particles may include analytes, such as bacteria, virus, or other target molecule to be detected. The well may be any type of device or contraption capable of contain liquid. In one example, the well may be made of aluminum or stainless steel. In another example, if the liquid has a volume of approximately 10 μL or less, the well may be a circular coil containing the liquid by surface tension.

The liquid may be any liquid capable of suspending, or solvating, the particles. Representative liquids include water, organic solvents, and ionic solvents. The liquid of the method may be a solution or a suspension and representative liquids include biological fluids such as blood, sputum, mucus, and saliva. Biological fluids, in particular, are typically highly complex and contain numerous particles including bacteria, cells, proteins, DNA, and other bodies. In one embodiment of the invention, the electrode may be immersed directly into a biological fluid extracted from a living being, such as a blood sample, mucus sample, saliva sample, or sputum sample. A particular analyte particle, such as tuberculosis bacteria, may be concentrated and immobilized on the electrode using the method of the invention. In one embodiment, the biological fluid may be processed between extraction from the living being and testing. Such processing may include acid and/or base treatment, dilution, chemical processing, heating/cooling, or other processing steps necessary to prepare the sample for use in the method. In one case, little or no preparation of biological fluids may be necessary for performing the methods of the present application, whereas extensive processing of samples may be used for previously known methods.

Referring back to block 102, the electrode may be immersed in the liquid so as to bring the electrode into proximity with the particles in the liquid to be immobilized. The electrode may entirely, or partially, immersed in the liquid.

At block 104, the method 100 may involve moving the at least one particle toward the electrode by vibrating the well. In one example, vibration of the well may create a convective flow within the liquid. The at least one particle may accordingly moves within the liquid due to the convective flow that may be created within the liquid. As a result of circulating throughout the liquid, more of the at least one particle may at some point move within a proximity of the electrode and become immobilized on a surface of the electrode. The well may be vibrated at different frequencies and different amplitudes. In one case, the well may be vibrated at a frequency in a range of approximately 10-1000 Hz in a longitudinal direction, with a displacement in the range of approximately 10-10,000 μm, to generate a convective flow.

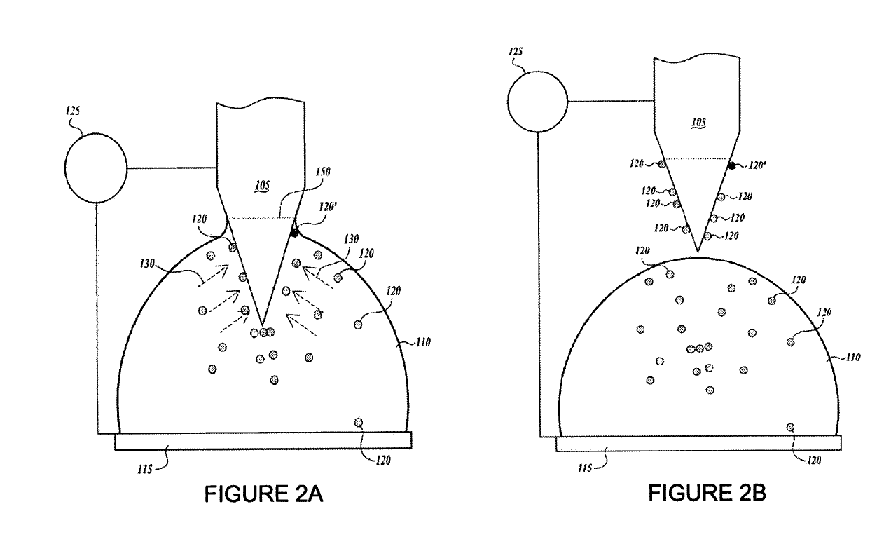

At block 106, the method 100 continues with the generation of an electric-field-induced force by the electrode that attracts the particles toward the electrode surface. In some examples, the electric field for inducing the electric-field-induced force may be in the range of 100,000 V/m to 750,000 V/m, at various frequencies. The electric-field-induced force may be an electrokinetic or dielectrokinetic force extending from the electrode and acting on the particles. Representative electric-field-induced forces include dielectrophoresis, electroosmotic flow, electrophoresis, and combinations thereof. In one embodiment, the electric-field-induced force may be generated between the electrode and a second electrode in contact with the liquid. The electric-field-induced forces typically utilizes the electrode and the second electrode to generate the force. The electrode may be in contact with the liquid because it is immersed in the liquid. The second electrode may also be in contact with the liquid and can be an electrode inserted into the liquid or may be a part of the well for the liquid, as will be discussed further with regard to FIGS. 2A-4.

The latitudinal cross-section of the electrode can have any shape. Representative shapes may include circular, triangular, and square cross sections. Conical electrodes may be useful because common micro- and nano-scale fabrication methods that may be used for making electrodes of the invention may result in conical-shaped electrodes (e.g., cutting meso-scale wire to a point or assembling nanowires into a conical structure). Representative electrodes may also include geometric-shaped cross-sections (e.g., square) that then truncate in a tapered distal end (“tip”), such as a circular cross-section wire that truncates in a conical or hemi-sphere tip.

Different types of electric-field-induced forces that may be used for the methods of the present application. A few examples are briefly described in the following. Dielectrophoresis (DEP) is a dielectric force wherein an induced dipole in the particle results in the attraction or repulsion of the particle to areas of high or low electric potential, based on whether the DEP effect is positive DEP or negative DEP. An alternating current may be used to drive the DEP force. In the embodiments described herein, positive DEP may be utilized to attract particles to the surface of the electrode.

Electroosmosis generates flow in the liquid that transports particles to the electrode through a drag force that results in particle concentration. When an AC field is applied to the electrode, an ion layer forms on the surface of the electrode. The sign of the charge of the electrodes (and the resulting double layer) may change according to the alternation of the potential. In such a case, an electrostatic force of charged ions may be generated in the tangential direction to the surface, which induces AC electroosmotic flow. The electric field strength decreases with increasing distance from the end of the electrode, and the flow speed may be maximal at the electrode distal end and decreases further up the shall of the electrode. Due to the non-uniform flow speeds resulting from field strength on the electrode, vortices may be produced in the liquid (that concentrate particles in the vicinity of the electrode).

FIG. 2A illustrates a diagrammatic view of a representative embodiment of the invention where an electrode 105 is immersed in a liquid 110 supported by a well with a well electrode 115. A plurality of particles 120 are suspended in the liquid 110. An electrical signal generator 125 may be operatively connected to the electrode 105 and the well electrode 115 to apply an AC and/or DC signal across the electrode 105 and well electrode 115. Depending on the shapes of the electrode 105 and well electrode 115, the applied signal from the electrical signal generator 125, the electric/dielectric properties of the particles 120, and the electric/dielectric properties of the liquid 110, several different electric-field-induced forces may be generated to manipulate the particles 120. FIG. 2A illustrates particles 120 influenced by DEP such that the particles 120 are attracted linearly toward the electrode 105 upon application of an electric field. The arrows 130 indicate the direction of the force on the particles 120 and the particles throughout the liquid are generally attracted in the direction of the electrode 105.

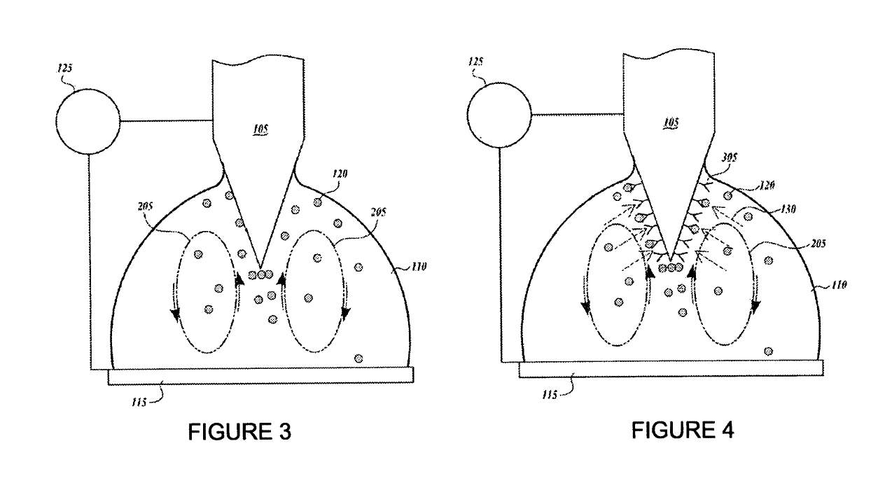

FIG. 3 is a diagrammatic view similar to that of FIG. 2A, with only the electric-field-induced force changing between FIG. 2A and FIG. 3. In FIG. 3, the electric field generated by the electrical signal generator 125 between the electrode 105 and well electrode 115 may result in electroosmotic flow, illustrated as oval circles 205 indicating that the electric field generates flow patterns within the liquid 110 creating a circular circling pattern within the liquid 110. Particles 120 may be influenced by the electroosmotic flow 205 and some particles 120 may be preferentially attracted toward the electrode 105.

FIG. 4 illustrates a system similar to those illustrated in FIGS. 2A and 3. FIG. 4 illustrates both electroosmotic flow 205 and DEP 130 and also includes a layer of first binding partners 305 coating the surface of the electrode 105. The first binding partners 305 preferentially bind to second binding partners that are attached to the particles 120. Thus, three forces are in effect in the system illustrated in FIG. 4, including electroosmotic flow 205 circulating the particles 120 within the liquid 110; DEP 130 preferentially attracting the particles 120 toward the electrode 105; and first binding partners 305, attached to the electrode 105, preferentially binding the second binding partners attached to the particles 120. The resulting forces culminate in the movement of particles 120 through the liquid 110 toward the electrode 105 upon the surface of which the particles 120 are concentrated. As indicated previously, the first binding partners on the electrode 105 may be streptavidin, and the second binding partner attached to the particles 120 may be biotin.

At block 108, the method 100 may involve immobilizing the at least one particle on a surface of the electrode with an electrostatic force. In one example, the same electric-field-induced force generated to attract the at least one particle may include an electrostatic force capable of immobilizing the at least one particle once the at least one particle is in contact with the surface of the electrode. In addition to the electrostatic force, binding partner interactions, as described previously, may also contribute to the immobilization of the particles on the surface of the electrode.

At block 110, the method 100 may involve withdrawing the electrode from the liquid. FIG. 2B illustrates a diagrammatic representation of the embodiment illustrated in FIG. 2A wherein the electrode 105 has been retracted from the liquid 110 and particles immobilized on the surface of the retracted electrode 105 remains on the surface due to the electrostatic force from the electrode. The speed of withdrawal of the electrode from the liquid can affect the size and number of particles immobilized on the surface of the electrode. The withdrawal speed may range from 1 μm/sec to 10 mm/sec.

Upon withdrawal of the electrode, the immobilization of the particles due to electrostatic force, and optionally binding partner interactions, may be further assisted by a capillary force to maintain the immobilized particles on the surface of the electrode. The capillary force formed at the interface between the electrode and the liquid and the ambient atmosphere (solid-liquid-gas boundary), may result in a force on the particles toward the surface of the electrode. The formation of the capillary force during withdrawal of the electrode is further discussed below in connection to another embodiment, wherein the capillary force may be more so relied upon to immobilize the particles than the present embodiment. Once the particles are immobilized on the electrode, upon withdrawal from the liquid, a variety of forces acting to keep the particles immobilized on the surface of the electrode may include capillary forces, chemical bonding, and electric-field-induced forces. The electric-field-induced forces may include electrostatic forces and other active electrical forces, (e.g., the electric signal continues to be passed through the electrode).

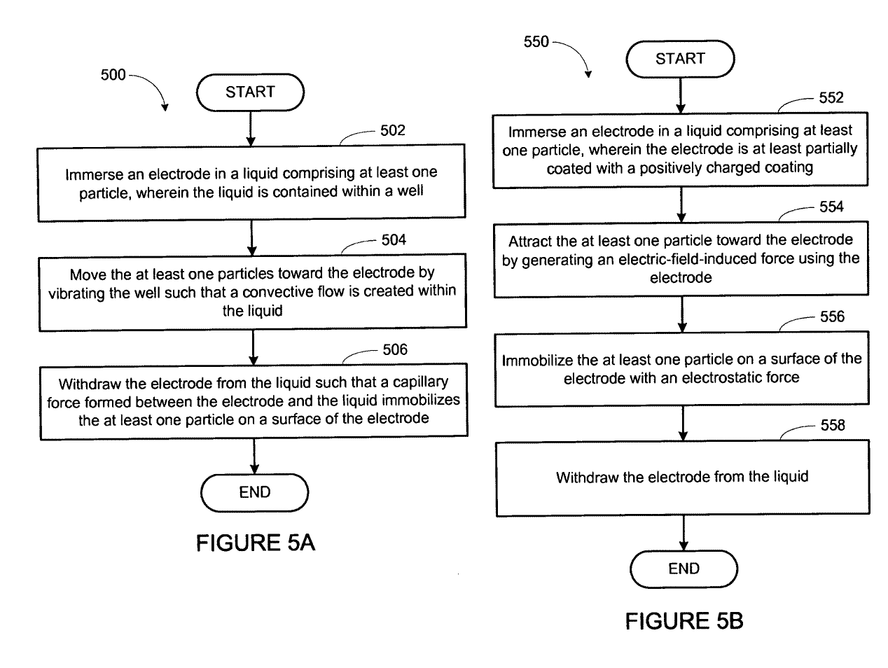

In addition to the method 100 as described above, alternative methods may also be implemented. Methods 500 and 550 as shown in FIGS. 5A and 5B, respectively, provide examples of alternate methods for concentrating particles. The method 500, as compared to the method 100, may omit the use of an electric-field-induced force to attract the at least one particle toward the electrode. The method 500 includes block 502-506, and may be directed to vibrating the well to create a convective flow within liquid to cause particles to move towards the immersed electrode, and immobilizing the particles on the surface of the electrode with the assistance of capillary forces formed during the withdrawal of the electrode. As shown, blocks 502 and 504 may be analogous to blocks 102 and 104 of the method 100 of FIG. 1, as discussed previously.

At block 506, method 500 involves withdrawing the electrode from the liquid such at a capillary force formed between the electrode and the liquid immobilizes the at least one particle on a surface of the electrode. Referring back to FIG. 2B, the electrode 105 from FIG. 2A has been retracted from the liquid 110. As illustrated, capillary action at the interface between the liquid 110 and the electrode 105 may have immobilized the particles trapped at that interface along the surface of the retracting electrode 105. For example, particle 120′ is illustrated in FIG. 2A at the interface between the electrode 105 and the liquid 110 where the surface tension is illustrated in an exaggerated manner for the purpose of clarity. As the electrode 105 withdraws from the liquid 110, the surface tension at the interface immobilizes the particles 120 adjacent to the electrode 105 on the surface of the electrode 105. FIG. 2B illustrates particle 120′ and other particles 120 immobilized on the surface of the retracted electrode 105.

As indicated previously, the speed of withdrawal of the electrode from the liquid can affect the size and number of particles immobilized on the surface of the electrode. Slower withdrawal speeds may be implemented to precisely control capillary action to helps determine the size and number of particles captured. In some cases, fast withdrawal speeds may be useful for devices that do not require precision operation (e.g., portable and/or disposable devices).

Immobilizing using capillary forces may be useful for immobilizing particles smaller than the latitudinal dimension (e.g., diameter) of the electrode at the solid-liquid-gas boundary. The balance of the forces for immobilizing particles on the electrode may be typically such that diameter of particles (assuming spherical particles) immobilized on the surface of the electrode are smaller than the diameter of the electrode (assuming a conical or cylindrical electrode shape).

For a conical electrode 105, as illustrated in FIGS. 2A-4, the diameter of the tip of the electrode may vary through the length of the conical portion of the electrode. As illustrated in FIGS. 2A and 2B, line 150 may represent a latitudinal diameter of the conical electrode at a particular position. The particles 120 immobilized onto an electrode from the liquid may all be smaller in diameter than the diameter of the electrode at line 150. The diameter gradient of the conical electrode 105 illustrated in FIGS. 2A and 2B may lead to the possibility that a gradient of maximum particle sizes will result from the use of such an electrode 105 shape in a liquid 110 containing multiple particle sizes. For a narrow maximum particle size distribution, cylindrical electrodes can be used.

Spherical particles are not required for the immobilization of the method of the invention to occur. It is convenient to use spheres for the purpose of representing particles, such as in FIGS. 2A-4, and for describing particles (e.g., particles having “a diameter”). However, spherical particles rarely occur at the micro- and nanoscales other than specifically formed micro- and nanospheres (e.g., polymer or inorganic nanospheres). In one embodiment, at least one dimension of the particle may be smaller than the latitudinal diameter of the electrode such that the combined forces of the electrically induced force, the size of the electrode, and the capillary force combine to immobilize the particle on the surface of the electrode.

As indicated previously, the particle may be selected from the group consisting of an organic particle, an inorganic particle, a virus, a bacteria, a nucleic acid, a cell, and a protein. Other particles, including biological particles, not recited herein, are also compatible with the methods described herein.

The method 550 of FIG. 5B, as indicated above, provides another alternative method for concentrating particles. As shown, the method 550 includes block 552-558. Block 552 may be analogous to block 102 of the method 100, block 554 may be analogous to block 106 of the method 100, block 556 may be analogous to block 108 of the method 100, and block 558 may be analogous to block 110 of method 100. As such, in comparison to method 100, the method 550 may omit vibrating the well to creative a convective flow to move the at least one particle toward the electrode.

Further, block 552 involves an electrode that may be at least partially coated with a surface coating. As suggested previously, the electrode can be coated for several purposes, including providing a buffer between the electrode material and the particles and/or the liquid; functionalizing the electrode to selectively bind to particles; and functionalizing the electrode to selectively repel particular types of particles (e.g., particles not desired for immobilization).

In one embodiment, the surface coating may be either a monolayer or a polymer layer. Monolayers, such as self-assembled monolayers (SAM), are known to provide a route to functionalize surfaces through grafting particular molecular species to the surface. For example, the bond between thiol and gold may be particularly well known to those of skill in the art and, thus, a gold electrode can be functionalized with thiol-containing molecules to produce a gold electrode having surface properties ranging from hydrophobic to hydrophilic and, additionally, customized chemical functionalities.

Polymer layers can also be used to coat the electrode. In one embodiment, the polymer may be a polysiloxane. An exemplary polysiloxane, such as polydimethylsiloxane (PDMS), may be used as a buffer between the conductive material of the electrode and the particles and liquid to preserve the integrity of the electrode material. In an exemplary embodiment, the electrode may be fabricated from a hybrid material of silicon carbide (SiC) nanowires and carbon nanotubes (CNT). The polymer protects the electrode from degradation due to exposure to the liquid and also prevents nonspecific binding between particles such as DNA and the CNTs of the electrode.

The surface coating at least partially coats the electrode. In an embodiment, the entire electrode may be coated with the coating. However, selectively coating only portions of the electrode may be utilized to direct particles toward or away from the portions of the electrode that are coated or uncoated.

In one embodiment, the surface coating enhances the immobilization of the particle on the electrode. The enhancement of the immobilization produced by the coating can be through any mechanism known to those of skill in the art. Particularly, by providing a hydrophobic or hydrophilic coating that preferentially binds particles having similar hydrophobic or hydrophilic character (e.g., a fluorinated alkane coating on the electrode will preferentially bind to particles having hydrophobic character through a hydrophobic-hydrophobic interaction).

Further, certain surface coatings may provide a less preferential attraction and immobilization of particles in the liquid. For instance, as mentioned previously, the electrode may be at least partially coated with a positively charged coating of poly-L-lysine (PLL) or polyethyleneimine (PEI), such that particles in the liquid are more uniformly attracted towards the electrode, than an electrode that is not at least partially coated with the positively charged coating. Similarly, if the electrode is at least partially coated with a precious-metal layer, particles in the liquid may be more uniformly attracted towards the electrode, than an electrode that is not at least partially coated with a precious-metal layer.

As also discussed before, the capillary force between the liquid and the electrode that is at least partially coated with the positively charged coating may be less than a capillary force between the liquid and an electrode that is not at least partially coated with a positively charged coating. In some cases, the capillary force may result in shifts of the particles along the electrode when the electrode is withdrawn from the liquid. As such, if the capillary force is reduced, and immobilization of the particles on the surface of the electrode is based primarily on electrostatic force and/or binding partner interactions, particles immobilized on the surface of the electrode may be more evenly distributed. In some case, the particles immobilized on the surface of the electrode may further be selectively distributed, based on other factors described herein.

In one embodiment, the surface coating includes a first binding partner and the particle includes a second binding partner capable of binding to the first binding partner. The utilization of such binding partners provides binding between the electrode and the particles when the particles are attracted or moved into close proximity to the electrode through the use of electric-field-induced forces in the liquid or convection flow created in the liquid through vibration of the liquid well. Example binding partners may include chemical binding partners, antibody-antigen partners, nucleic acid binding (e.g., DNA and/or RNA), enzyme-substrate binding, receptor-ligand binding, nucleic acid-protein binding, and cellular binding (e.g., a cell, cell membrane, or organelle binding to a ligand for the cell, cell membrane, or organelle). In one case as described previously, binding partners biotin and streptavidin may be used. For instance, the electrode may be coated with a layer containing streptavidin, such that particles in the liquid that have been conjugated with biotin may bind to the electrode more readily than particles not conjugated with biotin, when particles are in close proximity to the electrode. In some cases, the particles in the liquid may have been prepared such that specific particles may be conjugated with biotin before the electrode is immersed into the liquid.

Upon immobilization of particles on the electrode, several optional additional steps are provided for further treatment and processing of the concentrated particles, including analysis, storage, and release of the immobilized particles. In one example, further treatment of the electrode may involve evaporating the remaining liquid on the electrode with capillary action. In one case, the evaporation of the remaining liquid may be a complete evaporation. Further, as will be discussed below in examples, processing of the concentrated particles may involve detecting the at least one particle on the electrode directly or indirectly.

In another example, further treatment of the electrode having particles immobilized thereon may include rinsing the electrode and subsequently eluting the electrode. As such, methods 100, 500, and 550 may further involve immersing the electrode in a rinsing solution to remove non-specifically bound particles from the electrode. In case, if binding partner interactions were used to immobilize specific particles on the electrode (i.e. particles conjugated with biotin), then the rinsing solution may be used to remove particles other than the specific particles. In one example, the rinsing solution may have a temperature in the range of room temperature and 95 degrees centigrade.

Representative analytical techniques include techniques that occur while the electrode is immersed (e.g., resistance detection), and other techniques are performed out of solution. Representative analysis techniques include electrical, mechanical, optical, and surface-imaging techniques and combinations thereof. In one embodiment, optical analysis includes the steps of attaching a luminescent compound (e.g., a fluorescent tag) to the particle (e.g., a DNA molecule) to provide a luminescent particle and detecting luminescence from the luminescent particle using fluorescence microscopy and/or fluorescence spectroscopy.

The immobilized particles can be immersed in a second liquid that contains compounds that will interact with the immobilized particles to produce a particular effect, such as fluorescence. For example, DNA immobilized on an electrode can be immersed into a solution containing a molecule that fluoresces when hybridized with DNA. Upon hybridization with DNA, the DNA may be detectable by fluorescence spectroscopy.

Representative techniques for electrical detection of analyte particles include techniques for measuring capacitance, resistance, conductance, impedance, and combinations thereof.

In addition, the electrode may be stored to preserve the immobilized particles. In a representative embodiment, storing the electrode includes cryogenic freezing to preserve the immobilized particles. Cryogenic freezing optionally includes immersing the immobilized particles in a cryopreservative (e.g., DMSO) prior to freezing. The stored particles may be preserved for future analysis using the techniques described above, or may be further manipulated at a later time. In another example, the electrode may have been coated with PLL coating as suggested previously. In this case, the electrode may be stored, and the immobilized particles may be preserved at room temperature for up to six months.

In one case, the methods 100, 500, and 550 may further involve releasing the immobilized particles from the electrode. In one example, after rinsing the electrode, as discussed above, the methods 100, 500, and 550 may further involve immersing the electrode in an eluent liquid to elute the at least one particle from the electrode. The elution of the electrode in this case, may remove the immobilized particles from the electrode. The removed particles may then further treated for additional processing. In one example, the eluent liquid may have a temperature between room temperature and 95 degrees centigrade.

In another embodiment, the releasing of immobilized particles may involve releasing the particles from the electrode into a solution providing enrichment of such a solution with the previously immobilized particles. Releasing the immobilized particles can include releasing the particles into a body selected from the group including a cell, a virus, and bacteria. In other examples, immobilization and release may further be performed through manipulation of thermal energy, chemical energy, electric energy, mechanical energy, or combinations thereof.

In further aspects of the present application, a particle concentrating system may be provided on which the methods 100, 500, and 550 described above may be implemented. In one aspect, a particle concentrating system is provided. The particle concentrating system may include an electrode, a well containing liquid having at least one particle, a first actuator sized and configured to immerse and withdraw the electrode from the liquid, a second actuator sized and configured to vibrate the well such that a convective flow is created within the liquid, moving the at least one particle toward the electrode when the electrode is immersed, and an electric signal generator sized and configured to cause the electrode to produce an electric field to attract the at least one particle toward the electrode when the electrode is immersed in the liquid, and immobilize the at least one particle on a surface of the electrode when the electrode is withdrawn from the liquid.

In another aspect, a particle concentrating system is provided. The particle concentrating system includes an electrode, a well comprising liquid having at least one particle, a first actuator sized and configured to immerse and withdraw the electrode from the liquid such that a capillary force formed between the withdrawing electrode and the liquid immobilizes the at least one particle on a surface of the electrode, and a second actuator sized and configured to vibrate the well such that a convective flow is created within the liquid, moving the at least one particle toward the electrode when the electrode is immersed.

In yet another aspect, a particle concentrating system is provided. The particle concentrating system includes an electrode at least partially coated with a positively charged coating, a well comprising liquid having at least one particle, an actuator sized and configured to immerse and withdraw the electrode from the liquid, and an electric signal generator sized and configured to cause the electrode to produce an electric field to attract the at least one particle toward the electrode when the electrode is immersed in the liquid, and immobilize the at least one particle on a surface of the electrode when the electrode is withdrawn from the liquid.

These particle concentrating systems described herein has been described above with reference to the method of the invention and such aspects as the electrodes, liquids, and particles are applicable to both the method and the system.

The actuators sized and configured to immerse and withdraw the electrode from the liquid, and/or vibrate the well may be any actuator known to those of skill in the art, and in an example may be a mechanical actuator such as a piezoelectric actuator or a manually positionable actuator (e.g., a micromanipulator). The electric signal generator can be any signal generator known to those of skill in the art, such as those capable of delivering an AC and/or DC signal to the first and wells of the system.

In some examples, the systems may be fully automated devices having an electrode with optical and electrical detection units, as well as control units for all aspects of the device, such as the execution of the methods by the system may be performed automatically. In one example, a fully automated device may further be configured for analyzing the immobilized particles.

In addition to the systems and methods discussed above, other systems having additional electrodes, or pairs of electrodes are also contemplated and the electrical signal and actuation of each pair of electrodes can be controlled either independently of the other electrode pairs or in conjunction with the other electrode pairs. In these embodiments, the particles may be immobilized on the surface of the electrode using the electric-field-induced force, binding interactions, and/or capillary forces, as described above.

### Example Implementation of Particle Concentration Methods and Systems

The examples discussed hereafter are for purposes of illustrating how the subject matter of the present application may be implemented for different applications, and are not meant to be limiting or restrictive of the scope of the present application.

A. Extraction and Preservation of Genomic DNA from Human Samples

Extraction of human genomic DNA remains a bottleneck for genome analysis and disease diagnosis. Current methods using microfilters may use multiple handling steps in part because salt conditions should be controlled for attraction and elution of DNA in porous silica. We report an example extraction method of human genomic DNA from buccal swab and saliva samples. DNA is attracted onto a gold-coated microchip by an electric field and capillary action while the captured DNA is eluted by thermal heating at 70° C. A prototype device was designed to handle four microchips, and a compatible protocol was developed. The extracted DNA using microchips was characterized by qPCR for different sample volumes, using different lengths of PCR amplicon, and nuclear and mitochondrial genes. In comparison with a commercial kit, an equivalent yield of DNA extraction was achieved with fewer steps. Room-temperature preservation for 1 month was demonstrated for captured DNA, facilitating straightforward collection, delivery, and handling of genomic DNA in an environment-friendly protocol.

There may be needs for alternate methods to extract human genomic DNA from body samples. DNA extraction is also used for medical, forensic, environmental, or military purposes. Popular sources are saliva and buccal swab samples because the sample collection is minimally invasive.

For DNA extraction, solid-phase extraction methods using porous silica are commercially available. Cell lysates are infiltrated into silica micropores by high salt and chaotropic solutions, which bind DNA by electrostatic charge. After washing with alcohol, the DNA is eluted in a low salt solution by electrostatic repulsion. The extraction yield is high, butmultiple centrifuge steps are performed along with the use of toxic reagents. In the process, DNA can be degraded by alkaline solutions and flow-induced shear of DNA during centrifugation. For on-chip systems, silica chips, silica beads, or polymers can be integrated into microfluidic devices. However, the actual use is limited to a small sample volume (e.g., 1 μL). In microfluidic devices, electric-field induced methods have shown limited success to concentrate DNA in buffer solutions. DNA extraction from human samples using an electric field has yet to be demonstrated.

Preservation of DNA at room temperature is also useful for medical, forensic, environmental, and military purposes. In particular, long-term storage is a critical issue in genomic analysis and forensic applications. Preservation in aqueous solutions is detrimental to DNA molecules, susceptible to chemical changes. Extended storage requires freezing or the use of specialized preservatives.

This example provides a DNA preparation method. DNA is attracted onto a microchip using an AC electric field and capillary action. The captured DNA is eluted in buffer by thermal heating at 70° C. Two protocols for buccal swab and saliva samples are presented. Using real-time PCR (qPCR), the yield of DNA extraction is compared with that of a commercial kit.

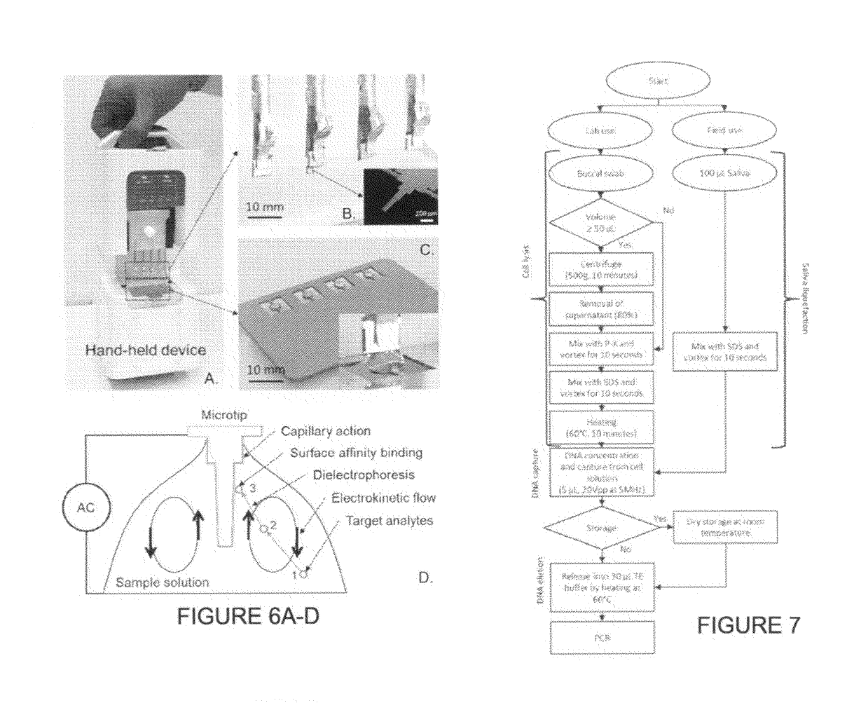

A DNA extraction device was designed to process four DNA samples in one batch (FIG. 6A). Four chips were loaded on a plastic coupon (FIG. 6B). Each individual chip has five microtips. In this example, “microtip” means one of five microtips in a microchip, “microchip” means a whole chip composed of microtips and a silicon chip, and “a microtip device” means a prototype device in FIG. 6A. The microtips were made of 1-μm-thick silicon nitride layer supported on a 500-μm-thick silicon layer. The top side of the microtips was coated with a 20-nm-thick gold layer for electrical connection and preservation of DNA. Metallic rings were used to suspend sample solutions by surface tension (FIG. 6C).

For device operation, four sample solutions of 5 μL were suspended in the metal rings. The chips were immersed into the sample solutions as shown in the inset image of FIG. 6C. An AC voltage of 20 Vpp (peak to peak voltage) at 5 MHz was applied between a chip and a ring for 30 s. The chips were withdrawn from the sample solutions at a speed of 100 μm/s with continuous application of an AC potential.

After complete withdrawal, the chips were dried for 2 min in air. In the evaporation process, DNA could be adhered and preserved on the Au surface of microchips at room temperature. The captured DNA was eluted in PCR tubes by immersing microchips in 30 μL of 1× Tris-EDTA (TE) buffer, pH8.5, at 70° C. for 4 min.

In the DNA extraction process, 20 Vpp was chosen to avoid electrical breakdown of sample solution on the microtips. In a study, λ-DNA spiked in buffer could be concentrated on to microtip surface by dielectrophoresis and electrokinetic flow. An electric field of 10 MHz and a DC bias showed the highest capturing yield measured by a fluorescence microscope. However, such conditions attracted other charged particles, which inhibited qPCR reactions. In our repeated tests using human samples, an AC field between 100 kHz and 5 MHz showed the highest yield in qPCR. In the frequency region, 5 MHz was chosen because frequencies below 1 MHz could potentially attract PCR inhibitors.

Two kinds of samples, buccal swab and saliva, were collected from de-identified volunteers. Buccal swab samples were evaluated for a laboratory protocol while saliva samples were evaluated for a field-deployable protocol (FIG. 7).

For buccal swab samples, Whatman (Piscataway, N.J.) omni sterile buccal swabs were used. After sample collection, the swab was completely dried. For elution of cells, the swab was immersed in 1 mL of 1×TE buffer (pH7.5, Invitrogen, Carlsbad, Calif., USA). After the vortexing of 30 s, sample volume of 700 μL was collected from one swab sample.

To evaluate the extraction yield, sample volumes of 5, 10, 50, and 100 μL were pipetted from a 700-μL extract. The sample solutions were lysed by using 600 AU/L proteinase-K (P-K) (Qiagen®, Valencia, Calif.) and sodium dodecyl sulfate (SDS) (Sigma-Aldrich, St. Louis, Mo.). For the large volumes of 50 and 100 μL, the sample solutions were centrifuged to make the final volumes of 10 and 20 μL, respectively. P-K of 1 μL (600 AU/L) and SDS of 4 μL (0.28 g/mL) were added per cell solution of 20 μL. After mixing of the reagents, the sample solution was heated at 60° C. for 10 min to lyse the cells. An aliquot of 5 μL was subjected to processing by the microtip device. The captured DNA was eluted in PCR tubes by immersing chips in 30 μL of 1×TE buffer (pH8.5) at 70° C. for 4 min. For a reproducibility test, 24 samples from different volunteers of 100 μL volume were tested only with the microtip device.

To compare the extraction yield with a commercial kit (Qiagen® QIAmp DNA mini kit), the sample volumes of 5, 10, 50, and 100 μL were also collected from the same extract in the same way as the microtip device. The 50- and 100-μL samples were not centrifuged before the use of the commercial kit. The commercial kit used about six centrifugation steps in the extraction process. To evaluate the potential damage of genomic DNA, both 100 and 1,500 bp of PCR amplicons were used for the extracted DNA from both the microchips and the commercial kit.

For saliva samples, SDS was added to obtain a final concentration of 0.08 g/mL. This was achieved by adding 4 μL of 2 g/mL SDS per 100 μL of saliva followed by vortexing for 10 s. The treatment may not have lysed cells but reduced the viscosity of saliva. Using microchips, DNA was captured from 5 μL of the processed samples. The captured DNA was eluted in PCR tubes in the same way as the buccal swab samples. For comparison with the commercial kit, 5 μL of the same saliva samples was used. For the evaluation of reproducibility, 24 saliva samples were tested by the microchips. To test the DNA integrity in 1-month preservation, 16 different chips were used to extract DNA from single sample mixture. The chips were stored in a vial at room temperature without dessicants. The DNA on the chips was tested at days 1, 8, 15, and 30 (n=4 for each day). For the commercial kit, the eluted DNA was also tested likewise in parallel.

To measure the yield of extracted DNA from the microchips and the commercial kit, qPCR was mainly used (see Electronic Supplementary Material for qPCR analysis and gene sequences). UV measurement and gel electrophoresis were also attempted. However, because the concentrations of DNA and protein were smaller than 1 μg/mL, the results were not reliable, and hence not reported.

When DNA was extracted from buccal swab samples with volumes of 5, 10, 50, and 100 μL, the average threshold cycles for the microtip device using the 100-bp amplicon were 23.92, 23.85, 21.22, and 21.87, respectively (FIG. 8A).

The corresponding threshold cycles of the commercial kit were 25.58, 24.47, 22.10, and 21.49, respectively. For 1,500 bp amplicon, the microtip devices yielded threshold cycles of 27.37, 26.37, 23.38, and 22.99 for the sample volumes of 5, 10, 50, and 100 μL while the corresponding cycles of the commercial kit were 28.99, 27.09, 24.95, and 23.69 (FIG. 8B). The performance of the microtip device was equivalent to that of the commercial kit in all volumes.

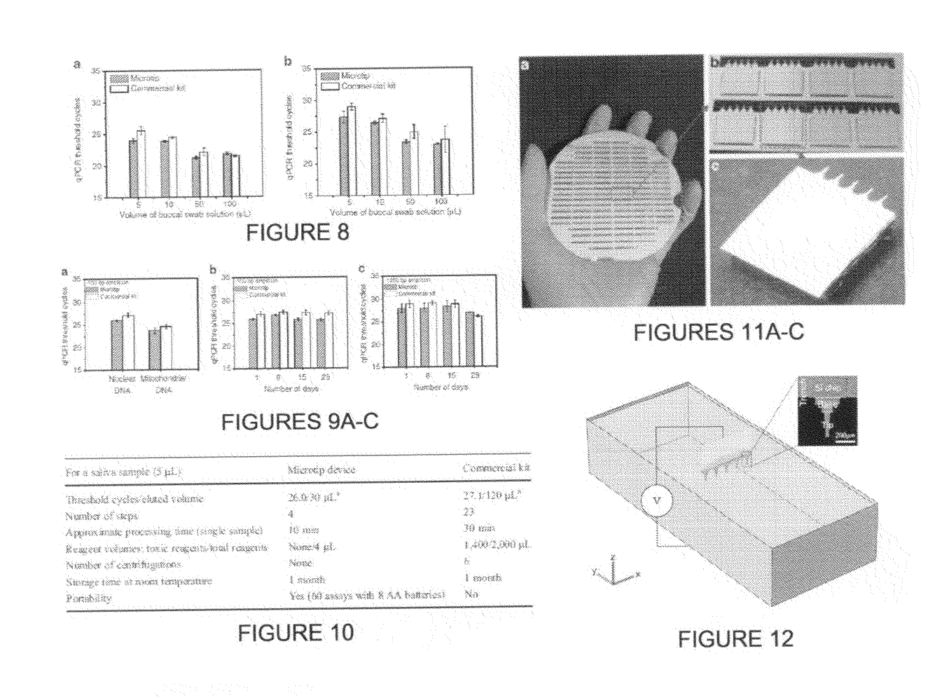

For saliva samples, the average threshold cycle of 100 bp amplicon of nuclear DNA for the microtip device was 25.95±0.21 while that of the commercial kit was 27.06±0.52 (FIG. 9A). The average threshold cycle for 100 bp amplicon of mitochondrial DNA for the microtip device was 23.71±0.65 while that of the commercial kit was 24.55±0.49. For the reproducibility test, DNA was extracted for 24 different saliva samples and tested only with microtip device. The threshold cycle using the microtip device was 25.18±1.50, which was also in the similar range of the average threshold cycle of the automated commercial device, 23.1±0.25 in literature. For a preservation test, both 100 and 1,500 bp amplicons were used (FIGS. 9B, 9C). The threshold cycles for 100 bp amplicon showed the better results than those for 1,500 bp amplicon by two cycles. The threshold cycles were maintained for 1 month without significant damage.

In working principle, the electric field and the capillary effect may have been dominant mechanisms for the DNA capture. To investigate the contribution of the capillary effect and the electric field, λ-DNA molecules were used for the comparison. When λ-DNA molecules were used for the recovery, the difference between in the presence and absence of an electric field was 7 cycles for λ-DNA molecules in buffer. When saliva samples were used, only 1˜2 cycle difference was observed with larger error bars in the absence of an electric field. The significantly higher yield in buffer could be caused by an electric field because dielectrophoresis was more dominant than capillary action in low-conductivity buffer. For saliva, capillary action became more dominant in complex samples.

In this example, both buccal swab and saliva samples were chosen in consideration of minimally invasive human samples. Both samples could be collected with minimal pain and treated with the reagents less than 5 μL. Such field collection capability was also aligned with the portable design of the microtip device. The device was designed to run 60 batches using eight of AA batteries. However, when the microtip device is applied for more complex human samples, such as blood, the DNA extraction protocol should be modified for more rigorous lysis and purification. For example, after capturing of DNA onto microtip surface, the tip should be washed to remove excessive protein and reagents. Such protocols are being developed to apply the microtip device for various samples.

In terms of an extraction yield of genomic DNA, the microtip device was similar to the commercial kit within an error range. In case of the buccal swab samples, the threshold cycles by qPCR were similar between the microtip device and the commercial kit. When four microchips ran for 100 μL of buccal swab samples, the total volume of the extracted DNA in buffer was 120 μL, which was similar to the elution volume of the commercial kit. Thus, the total mass of DNA was equivalent for the microtip device and the commercial kit. In the case of the saliva samples, the microtip device advanced the commercial kit by one or two cycles. But the elution volume was one quarter of the commercial kit. In an error range of 5% (i.e., 1.5 in 30 cycles of qPCR analysis), the total mass of DNA was equivalent for both kits.

In terms of the procedure time, the example microtip device may be faster and simpler than the commercial kit. The microtip device could extract DNA from saliva within 10 min. The commercial kit used about 30 min for one sample, including multiple centrifugation processes. The microtip device did not use a centrifugation step for the volumes smaller than 50 μL, which could reduce potential human errors. The centrifuge-free process could be also useful for zero-gravity environment, such as space applications.

In combination with the process, the microchip did not use any toxic solutions. Moreover, the smallest sample volume for DNA extraction was 1 μL with microtip. In the smaller volume, even the volume of reagent will be negligible. Therefore, the microtip device could facilitate environment-friendly extraction. The commercial kit used 2,000 μL of liquid phase reagents including 1,400 μL of toxic reagents, which also increased the risk of contamination. The performance of the microtip device is summarized in FIG. 10 in comparison with the commercial kit.

The microtip-based method could cause less shear of DNA than a porous silica-based method, which may be useful for long-range PCR. To compare the damage of DNA in the microtip device and the commercial kit, gel electrophoresis and atomic force microscopy (AFM) were used for recovery study of λ-DNA from buffer. By gel electrophoresis, the band of the microtip device was similar to that of the original λ-DNA solution. In contrast, the λ-DNA by the commercial kit appeared damaged, which was shown as the smeared band. However, in the qPCR analysis, the threshold cycles were the same. In qPCR using buccal swab samples, large error bars were observed for 1,500 bp (FIG. 8B), indicating the damaged DNA molecules. In our AFM study, DNA of K562 human leukemia cells was extracted by the microtip device and the commercial kit. A few micrometer-long DNA was easily found for the microtip device. However, the presence of long DNA could not be clearly observed for the commercial kit. Considering the gel electrophoresis, AFM, and qPCR results, the microtip device could damage DNA less than the silica-based microfilters.

One feature of the example microtip device is the capability of long-term preservation of genomic DNA in a dried form at room temperature. The preservation of DNA in liquid is known to damage more DNA than that under dried condition. The storage capability enables field collection of DNA and does not require freezers or refrigerators, which has been a challenge for forensic analysis. One month storage of DNA from saliva samples was demonstrated in FIG. 9C. In addition, the DNA extracted from human cells could be preserved for 6 months. The capability of the room temperature preservation renders the microtip device ideal for field-deployable collection of genomic DNA from saliva samples. Further preservation test for a long term (e.g., year) should be conducted to assess storage of DNA in a dried condition.

For the scalability of the microtip device, the microchips are manufactured as an array by microfabrication steps. Using a 100-mm-diameter Si wafer, 350 chips are manufactured in one wafer (FIGS. 11A-C). Typically 25˜50 wafers are processed in one batch, which can significantly reduce the manufacturing cost and thus the assay cost. For a higher throughput, the microtip device does not require centrifuge steps, which yields the flexibility for a microwell-plate compatible design. For example, a 96 well-plate compatible microtip device can be developed to handle 96 samples simultaneously, which will be future work of the microtip device.

As described above, a prototype microtip device was developed and characterized for DNA extraction by using microtips. A combination of an electric field and capillary action was used for attraction of DNA while thermal heating was used for the elution. The extraction yield in terms of qPCR was equivalent to that offered by a commercial kit. The environment friendly steps with less reagent could complete the DNA extraction less than 10 min from small-volume saliva samples. The process can also significantly reduce the assay cost and potential human errors. The long-term storage capability can facilitate easy collection of DNA for developing a database of human genomic DNA from saliva. The microtip device can potentially benefit human genome projects, disease diagnosis, and forensic analysis by reducing the initial barrier of high-throughput sample preparation.

B. Example Electric Field-Induced Concentration and Capture of DNA onto Microtips

Concentration of DNA may be useful for high-throughput genetic analysis and disease diagnosis. Glass-based microfilters are popular but the process uses centrifugation steps with additional chemical processes. As an alternative, a concentration method using an electric field has been explored. In this discussion, electric field-induced concentration and capture of DNA are studied by using high-aspect-ratio microtips coated with a gold layer. The microtips are immersed longitudinally into a solution of 100 μL, containing λ-phage DNA. After DNA concentration using an electric field, the microtips are withdrawn from the solution. Under AC- and biased AC fields, DNA is concentrated by electrophoresis (EP), dielectrophoresis (DEP), and electroosmotic flow (EOF). To reduce capillary effects in the withdrawal process, the microtips are coated with positively charged poly-_{L}-lysine (PLL). The pattern of captured DNA is analyzed by fluorescence microscopy. DEP attracts DNA molecules at the edges of microtips, where the highest gradient of electric field exists. EP attracts DNA onto the surface of microtips following the vectors of an electric field. EOF generates vortexes that deliver DNA onto microtips. Using this method 85% of DNA is captured on the PLL-coated microtips after three sequential captures. The concentration mechanism can potentially facilitate preparation of DNA for downstream analysis.

Concentration, purification and recovery of DNA may be useful for disease diagnosis and genome sequencing. Current concentration methods using glass matrices are cumbersome with multiple centrifugation and microfiltration steps combined with the use of alcohol or chaotropic solution. Centrifugation can potentially damage DNA by hydrodynamic shear force in microfilters. The use of alcohols can denature DNA. For example, past studies on centrifugation-based methods have shown that plasmid DNA of 10-20 kb in length was fragmented by shear force, as was chromosomal DNA.

Biased AC fields may yield higher concentration of DNA than AC fields. A study shows DNA concentration on a nanotip using an AC electric field at 5 MHz, which demonstrated DNA detection at 7 pg/mL in a 2-4 sample volume. In all the above experiments, limited concentration performance of DNA was observed in sample volumes smaller than 20 μL. Bioassays frequently use sample volume larger than 100 μL, which can be useful for improving the sensitivity of biosensors.

In this example, a microtip concentrator is designed to concentrate and extract DNA on to a microtip surface using electric fields. The captured DNA can be used for downstream analysis or potentially stored at room. As a fundamental study, this discussion presents a microtip-based concentration of DNA for various electric fields including DC, AC and biased AC at various frequencies and immersion times. For DNA concentration, a high electric field of 7.4×10⁵ V/m is applied between gold-coated microtips and an aluminum well containing 100 μL volume of λ-DNA solution. To reduce capillary-induced effects upon microtip withdrawal poly-_{L}-lysine (PLL) is coated on microtips for electrostatic capture. The captured DNA is dyed with PicoGreen and analyzed by a fluorescence microscope. To understand the pattern of attracted DNA molecules on the microtips, numerical simulation results were compared with experimental results. This description discusses microtip-based concentration and extraction of DNA using electric fields and capillary action.

The experimental configuration in this example is composed of an array of microtips and a rectangular well (FIG. 12) that can hold 100 μL of sample solution. The microtip array is composed of 5 microtips each with 1 μm in thickness and 50 μm in width at the tip part. Both micro tips and well are electrically conductive. The microtips are immersed into λ-DNA solution in direction. When an electric field is applied to the microtip array immersed in the well, DEP, EP, and EOF can be generated. After concentrating DNA on the microtip surface, the microtip is withdrawn from the well. This induces capillary action to either retain or release the concentrated DNA.

To understand the effect of EP, DEP and EOF on the concentration of DNA, numerical computation was conducted. The purpose of the numerical study is to understand the attracted pattern of λ-DNA molecules on a microtip surface for EP, DEP and EOF. The DNA pattern on the microtip surface is compared to experimental results, yielding a basic understanding of the concentration mechanism to enhance the capturing yield. For analysis, λ-DNA was modeled as a microsphere. A quarter model of FIG. 12 was used in the numerical study. The model, boundary conditions and values of various parameters for simulation are described in the supplementary information.

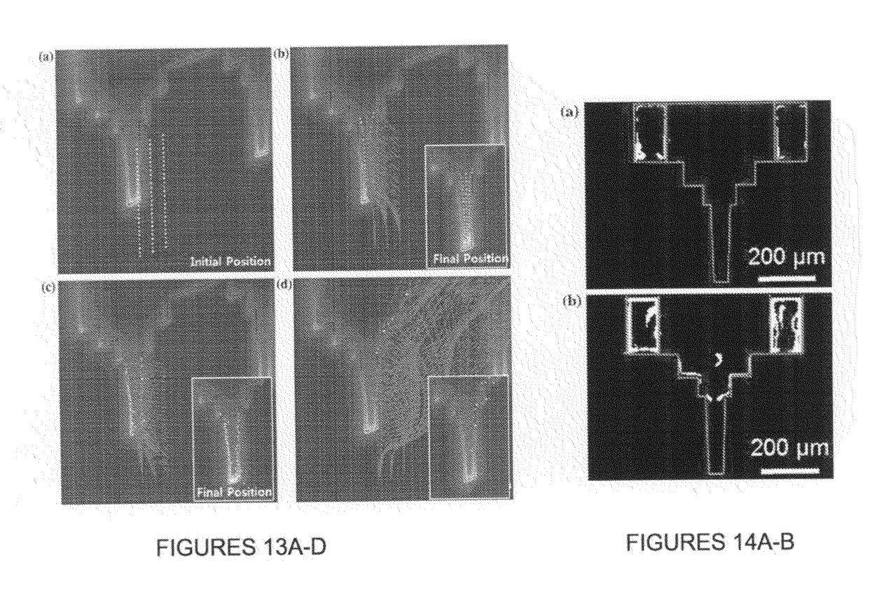

For basic working principles, EP is the electrostatic motion of a charged particle under an electric field. Negatively charged DNA molecules move toward positive electrode in an electric field. For the numerical results, microspheres at initial locations are attracted along the vectors of an electric field and deposited on both edges and surfaces of microtips depending on the initial position of a microsphere in medium (FIGS. 13A, 13B).

DEP is the movement of a particle in a non-uniform electrical field due to the induced dipole moment. The magnitude of DEP force depends on the volume of a sphere, the polarizability of a sphere and a medium, and the gradient of squared electric field. In the given geometry of a microtip, mihospheres are attracted to an edge of microtips due to a higher gradient of an electric field (FIG. 13C).

In the presence of an electric field, a thin ionic layer forms on the surface of a microtip. The charged ions in the electrical double layer between the surface and the electrolyte experience an electrostatic force when an electric field is applied. The unbalance of charges on electrodes generates EOF acting as electrokinetic pumps. In the given geometry of microtips, microspheres are transported to the microtip surface by the convective vortexes, but returned to the bulk fluid without other attractive forces (FIG. 13D). According to our experimental observation using polystyrene beads (diameter 19.0 μm) in 1×TE buffer, EOF was observed at the frequencies between 1 kHz and 5 MHz (Supplementary Information). At frequencies over 10 MHz, EOF may be negligible. At such high frequencies, the ions may not respond to an electric field because the change of electric polarity on electrodes could be higher than ion mobility.

As shown, DNA can be attracted to both edge and surface of the microtip by EP and to the edge by DEP, EOF can deliver DNA to the microtip but carry it away from the microtip due to the circulation flow.

The experimental setup is illustrated in FIG. 12. Microtips were dipped and withdrawn in the solution along the z axis, which was controlled by a linear motor. An electric field was applied by a signal generator (Agilent 33220A) between the aluminum well and the microtips. The microtips were designed to increase the efficiency of capture by increasing the strength of an electric field through the high aspect ratio. In particular. a saw tooth profile was patterned at the edge of microtips, which could increase the strength of an electric field by accumulating electric charges at the edge. Once attracted, DNA could be captured on the micro tip surface. The fabrication procedure of the micro tip is given in the supplementary information.

A well was made of conductive aluminum foil of 12 mm×2 mm×2.5 mm that could contain 100 μL of sample solution. The vibration of the aluminum well was applied to circulate the DNA solution. The vibration amplitude was 100 μm in a longitudinal direction at 60 Hz. This circulation flow was not considered for the numerical analysis because the flow velocity in the vicinity of the microtip surface was close to 0 μm/s.

Bacteriophage λ-DNA (48.5 kbp, 31.5 kDa) was purchased from New England Biolabs (Ipswich, Mass.). The concentration was 500 μg/mL (16.2 nM) in 1× Tris EDTA (TE) buffer of 7.5 pH. Further dilutions to 1 nM were made with 1× Tris ETDA buffer of 7.5 pH. A green interrelating dye (PicoGreen®, excitation and emission wavelengths: 480 and 520 nm, respectively) was purchased from Invitrogen (Carlsbad, Calif.). After 200-fold dilution with 1×TE buffer, PicoGreen was mixed with equal volume of 1 nM λ-DNA. The mixture was incubated for 5 min at room temperature before the experiment.

The captured λ-DNA on microtips was imaged by a fluorescence microscope (Olympus BX-41). The fluorescence images of both front and back sides of microtips were captured and digitized into black and white pixels. The threshold value was determined to minimize the fluorescence signals of negative controls. Using the threshold, the most pixels in negative control signals were converted into black dots. Through this image processing, captured DNA could be effectively located and quantified on microtip surface. After digitization, the white pixels of the images were summed to yield fluorescence signals showing the location and amount of DNA.

The first set of experiments was conducted with gold-coated microtips, which are referred as ‘non-coated microtips’ in this paper. The effects of frequencies and immersion time were studied for concentration of λ-DNA. The frequencies were varied from 100 Hz to 10 MHz. In addition to an AC field, a bias of 3 V (DC field) was added to observe the effect of a biased AC field. The test was also conducted without an electric field to assess. DNA capture by capillary action alone. A negative control experiment without DNA was conducted only with the PicoGreen® dye. The immersion time for the frequency tests was 1 min. The fluorescence signals from five microtips were averaged after the capture.

Based on the results of the frequency study, tests for immersion time were conducted for selected electric fields. The electric fields were 100 Hz AC, 10 MHz AC, 1 kHz biased AC, and 10 MHz biased AC. A DC field was not chosen because it could have EP similar to 100 Hz. For AC fields, 100 Hz was chosen because the fluorescence signal was highest in the frequency study. 10 MHz was also chosen to observe how DEP affected the concentration without EOF. For biased AC fields, 1 kHz was chosen because the highest fluorescence signal was observed in the frequency test 10 MHz was also chosen to observe the DNA capture using DEP and EP. The immersion time periods were varied from 1 up 8 min until a steady decrease of fluorescence signals was measured.

A second set of experiments was conducted with the microtips that were coated with PLL (0.1% w/v in water; Sigma-Aldrich P8920) on top of the gold layer of microtips. The microtips were immersed into PLL solution for 5 min and were cured for 2 min at 200° C. The cationic polymer layer could retain the negatively charged DNA on microtip surface. The microtips are referred as ‘PLL-coated microtips’ in the paper. Using an AC field at 10 MHz, the immersion time was varied from 1 to 10 min, and fluorescence signal was measured. A similar experiment was also conducted for a biased AC field of 10 MHz varying the immersion time until the fluorescence signal continuously decreased. To assess the reproducibility using PLL-coated microtips, additional experiments for 10 MHz AC and 10 MHz biased AC fields were conducted at 4- and 10-min immersion times, respectively. For biased AC fields, a bias of 3 V DC was added to AC potentials in serial connection.

To estimate the total amount of captured DNA using microtips, ten sequential immersions from the same well were conducted using ten different microtips. A 10 MHz biased AC field at 20 Vpp was used to capture λ-DNA. The immersion time was 10 min for each DNA capture. Due to the evaporation of the solution during the experiments, 10 μL of DNA-PicoGreen mixture was refilled into the well after each capture.

DNA capture was studied for DC, AC and biased AC electric fields. Different frequencies for both AC and biased AC ranging from 100 Hz to 10 MHz were studied. When an electric field was applied, DNA was concentrated on the microtips. In the case of DC field, only 3 V was applicable without causing bubble formation at the microtips.

FIGS. 14A-B shows the digitized fluorescence signals on non-coated microtips for 1 MHz AC and 1 MHz biased AC. The signal was observed only on the edges of the base and in the rectangular trenches. When the microtips were withdrawn from the solution, the DNA at the rip part was removed from the microtips due to the capillary force. Hence, these images may not be directly compared with the simulation results. On the base part of the microtips, the attracted DNA was concentrated along the meniscus of the trapped solution on the microtip surface because of evaporation of the solution drop. The fluorescence signal was also observed at the rectangular trench on the Si chip part. The rectangular trench was generated during the ME step in the fabrication of microtips. The 1 μm-deep trenches generated capillary action to further concentrate captured DNA along the rectangular edges. Overall, the bias increased the signal magnitude.

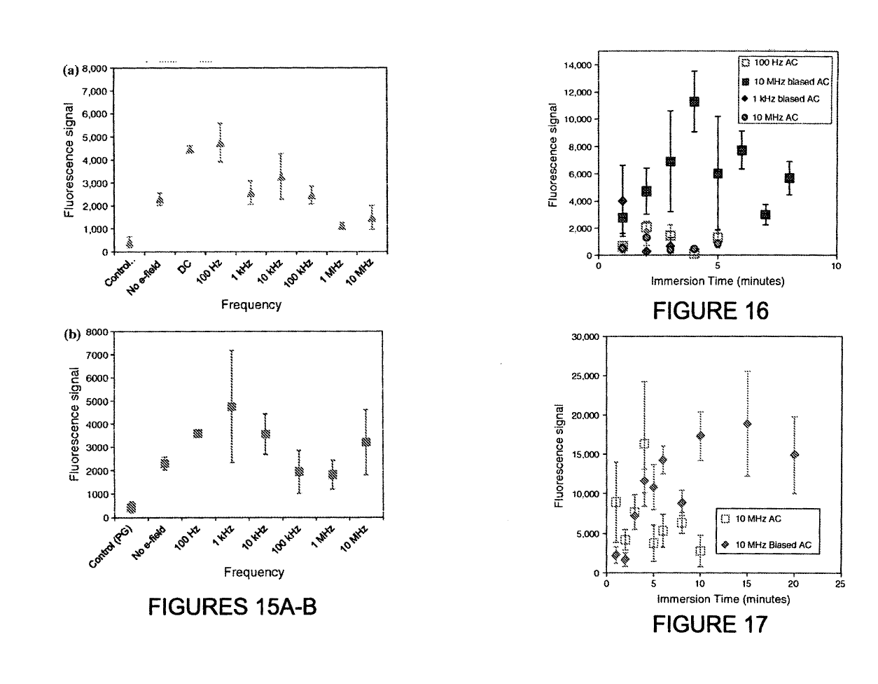

Without an electric field, about 0.5 μL of the solution containing DNA was captured on the microtips due to capillary action. The fluorescence amplitude without an electric field was 2,299 in FIG. 15A. In the frequency study using AC fields, the highest fluorescence signal was measured at 100 Hz (FIG. 15A). As the frequency increased, the signal decreased steadily.

In the case biased AC, the highest fluorescence signal was observed at 1 kHz (FIG. 15B). Overall, higher fluorescence signals were observed between 100 Hz and 10 kHz, which was consistent with previous results using planar electrodes. In comparison with the fluorescence signal of an AC field, that of a biased AC field was increased only at the frequency of 10 MHz (FIG. 15B). At such a high frequency, DNA concentration could be driven solely by DEP while the EOF component was negligible. By adding a DC field, EP force could attract and capture more DNA.

FIG. 16 shows the immersion time responses for non-coated microtips. For AC fields, the immersion time was varied for the selected frequencies of 100 Hz and 10 MHz. 100 Hz was the frequency yielding high-fluorescence signals. 10 MHz was selected to study the effect of DEP without EOF. The fluorescence signals for AC fields were fluctuating regardless of immersion time. For biased AC fields, the fluorescence signal for 1 kHz was decreased with increase of the immersion time while that for 10 MHz biased AC was increased up to 4 min. The fluorescence signal for 10 MHz biased AC was decreased after 4 min. For both AC and biased AC fields below the frequency of 10 MHz, the fluorescence signal was reduced when the immersion time was greater than 1 min. The reduced signal could be caused by EOF or capillary action that might remove the attracted DNA from microtip surface.

To improve the yield of DNA capture, PLL-coated microtips may be used. With PLL-coated microtips, both 10 MHz AC and 10 MHz biased AC fields were studied as a function of immersion time. The captured pattern of DNA on non-coated- and PLL-coated microtips was compared.

FIG. 17 shows the immersion time responses of PLL-coated microtips for both 10 MHz AC- and 10 MHz biased AC field. Overall, the fluorescence signals of PLL-coated microtips were significantly greater than those of non-coated microtips. The fluorescence signal for a 10 MHz AC field was observed at 4 min of immersion time. The fluorescence signals dropped significantly after 4 min. For biased AC field, the signal was saturated at 10 min. Therefore, the bias could accumulate the concentrated DNA by electrostatic force on a PLL layer.

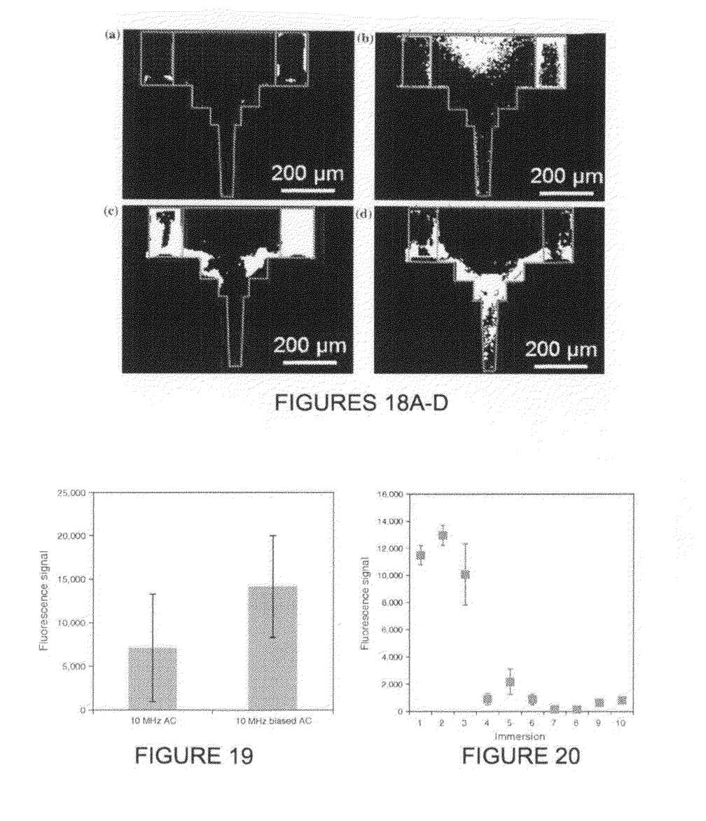

The digitized fluorescence signals for an AC field of 4 min immersion are shown in FIGS. 18A and 18B for non-coated- and PLL-coated microtips, respectively. For PLL-coated microtips, DNA was located along the microtip edges of a high electric field strength because DNA was attracted by DEP. DNA was also found at the trenches because DNA was partially aggregated by capillary action. However, for non-coated microtips, fluorescence signals were mainly found at the rectangular trenches but not at the edges due to capillary action (FIG. 18A).

Overall, the absence of fluorescence signal at the tip part of the non-coated microtips showed that the capillary action was dominant in removing the concentrated DNA. Fluorescence signals were also observed in the rectangular trenches because of capillary action. PLL-coated microtips could hold the captured DNA along the microtip edges where DEP was highest (FIG. 18B). This is also shown in the simulation results of DEP in FIG. 13C, where the particles are attracted to the edges of the tip part.

For biased AC fields, digitized fluorescence images of non-coated- and PLL-coated microtips are shown in FIGS. 18C and 18D, respectively. For non-coated microtips, fluorescence signals were mainly observed at the trenches and the base part of microtips (FIG. 18C). A DC field introduced EP in addition to DEP, enabling the retention of more attracted DNA. For PLL-coated microtips (FIG. 18D), fluorescence signals were observed both at tip- and base parts of microtips. As observed earlier, non-coated microtips could not retain the DNA attracted to the tip part while the PLL-coated tips retained the captured DNA as attracted. For PLL-coated tips, a significant portion of the DNA was captured onto the edges of the microtips while the fluorescence signal was relatively small in the trenches. Comparing with the simulation results (FIGS. 13A-D), a coinciding pattern of EP and DEP could be observed on the tip part.

Interestingly, when a biased AC field was applied, the fluorescence amplitudes for both non-coated- and PLL-coated microtips were very similar for 4 min immersion. The average amplitudes for non-coated- and PLL-coated microtips for 10 MHz biased AC were 11,270 (FIG. 16) and 11,554 (FIG. 17), respectively. For PLL-coated microtips, however, the fluorescence signals for a 10 MHz AC field decreased after 4 min of immersion. For a 10 MHz biased AC field, the fluorescence signal was saturated within an error range at immersion time of 10-20 min.

To assess the reproducibility of the results, three sets of additional experiments were conducted using PLL-coated microtips (FIG. 19). Both AC and biased AC fields were used to capture λ-DNA. For 10 MHz AC, the capture was performed at 4-min immersion time. For 10 MHz biased AC, the capture was performed at 10-min immersion time when the fluorescence signal was saturated. On the average, a biased AC field showed a higher yield than an AC field.

In summary, a PLL layer was beneficial to retain captured DNA. The capture of DNA was dependent upon electric fields. DC bias improved the yield of DNA capture. Under DEP, DNA was attracted toward the edge of PLL-coated microtips (FIG. 18B). Under both DEP and EP, DNA was attracted to both edge and surface of PLL-coated microtips (FIG. 18D). These observations were consistent with the numerical results in FIGS. 13A-D.

To estimate the capture yield using PLL-coated microtips, ten consecutive captures in the same well containing λ-DNA were conducted. A 10-MHz biased AC field at 20 V pp was applied for immersion time of 10 min. For the first three captures, the fluorescence signals were significantly higher in comparison with the other consecutive runs (FIG. 20). Assuming the total signal for 10 runs was equal to the whole DNA amount in the sample solution, nearly 85% of the fluorescence signals were measured from the first three captures. An approximate correlation between the fluorescence signal and DNA concentration in FIG. 20 shows that 10,000 fluorescence units correspond to 0.76 μg of λ-DNA.

In the microtip test, the concentration mechanism changes depending on frequencies. EP is effective between 0 and 1 kHz where the DNA mobility is greater than the polarity change of the potential in DC and AC fields. DEP is constantly effective in the frequency range of 0-10 MHz. EOF is effective between 1 kHz and 5 MHz according to our experimental and analytical results. Considering the results, a DC field can add EP to the phenomena of an AC field. The study of EP, DEP, and EOF my provide a guideline in designing DNA concentration methods. The operational parameters for capturing DNA from a sample mixture need further optimization based on these results. The optimization can depend on integrity of DNA and contaminants for down-stream analysis including PCR-based methods and gel electrophoresis.

The concentration of DNA onto microtips using electric fields was studied by experiment to understand the effect of EP, DEP, and EOF. Using ‘non-coated’ microtips, high fluorescence signals were observed at a 100-Hz AC field and a 1-kHz biased AC field for 1 min immersion. DNA captured on the non-coated microtips was rearranged when removed from the solution due to capillary action. To retain DNA on microtip surface as attracted, microtips coated with a positively charged PLL layer were used. With increased immersion time. ‘PLL-coated’ microtips exhibited increased capture yield of DNA at a biased AC field of 10 MHz. Total 85% of DNA in a 100 μL well was captured on the PLL-coated microtips with three sequential captures with 10 min immersion at a biased AC potential of 20 Vpp at 10 MHz. Numerical simulation was conducted to understand the pattern of DNA concentration under EP, DEP, and EOF onto the microtips. DNA was attracted to both surface and edge of microtips by EP while DNA was attracted to the edge of the microtips by DEP, EOF transported DNA to the microtips through vortexes.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

We claim:

1. A method for concentrating a particle, comprising:
(a) immersing an electrode in a liquid comprising at least one particle, wherein the liquid is contained within a well;
(b) moving the at least one particle toward the electrode by vibrating the well such that a convective flow is created within the liquid;
(c) attracting the at least one particle toward the electrode by generating an electric-field-induced force using the electrode;
(d) immobilizing the at least one particle on a surface of the electrode with an electrostatic force; and
(e) withdrawing the electrode from the liquid.

2. The method of claim 1, wherein the electrode is at least partially coated with a positively charged coating.

3. The method of claim 2, wherein the positively charged coating comprises a poly-L-lysine (PLL) coating.

4. The method of claim 2, wherein the positively charged coating comprises a polyethyleneimine (PEI) coating.

5. The method of claim 2, wherein the at least one particle comprises different types of particles, and wherein at least one type of particle is more uniformly attracted toward the electrode that is at least partially coated with the positively charged coating than an electrode that is not at least partially coated with the positively charged coating.

6. The method of claim 2, wherein there is a capillary force between the liquid and the electrode that is at least partially coated with the positively charged coating, wherein the capillary force between the liquid and the electrode that is at least partially coated with the positively charged coating is less than a capillary force between the liquid and an electrode that is not at least partially coated with a positively charged coating.

7. The method of claim 1, wherein the electrode is at least partially coated with a precious-metal layer.

8. The method of claim 7, wherein the at least one particle comprises different types of particles, and wherein at least one type of particle is more uniformly attracted toward the electrode that is at least partially coated with the precious-metal layer than an electrode that is not at least partially coated with the precious-metal layer.

9. The method of claim 1, wherein the electrode is at least partially coated with a biotin-recognition layer.

10. The method of claim 9, wherein the at least one particle comprises particles conjugated with biotin and particles not conjugated with biotin, and wherein the particles conjugated with biotin are more attracted to the electrode than the particles not conjugated with biotin.

11. The method of claim 1, wherein the at least one particle immobilized on the surface of the electrode comprises specifically bound particles and non-specifically bound particles, the method further comprising:
(g) immersing the electrode in a rinsing solution to remove the non-specifically bound particles from the electrode; and
(f) immersing the electrode in an eluent liquid to elute the at least one particle from the electrode.

12. The method of claim 11, wherein the eluent liquid has a temperature between room temperature and 95 degrees centigrade.

13. The method of claim 11, wherein the rinsing solution has a temperature between room temperature and 95 degrees centigrade.

14. The method of claim 1, further comprising
(h) evaporating remaining liquid on the electrode with capillary action; and
(i) detecting the at least one particle on the electrode.

15. The method of claim 1, wherein the well is vibrated at a frequency in a range of approximately 10-1000 Hz in a longitudinal direction to generate a convective flow with a displacement in a range of approximately 10-10,000 um.

16. The method of claim 1, wherein the electrode comprises a branched dentrite structure.

17. The method of claim 1 wherein the well is a circular coil, wherein the liquid has a volume less than approximately 10 μL, and wherein the liquid is contained within the circular coil by surface tension.

18. A method for concentrating a particle, comprising:
(a) immersing an electrode in a liquid comprising at least one particle, wherein the liquid is contained within a well;
(b) moving the at least one particle toward the electrode by vibrating the well such that a convective flow is created within the liquid; and
(c) withdrawing the electrode from the liquid such that a capillary force formed between the electrode and the liquid immobilizes the at least one particle on a surface of the electrode.

19. The method of claim 18, wherein the well is vibrated at a frequency in a range of approximately 10-1000 Hz in a longitudinal direction to generate a convective flow with a displacement in a range of approximately 10-10,000 um.

20. The method of claim 18, further comprising
(d) evaporating remaining liquid on the electrode with capillary action; and
(e) detecting the at least one particle on the electrode.

21. A method for concentrating a particle, comprising:
(a) immersing an electrode in a liquid comprising at least one particle, wherein the electrode is at least partially coated with a positively charged coating;
(b) attracting the at least one particle toward the electrode by generating an electric-field-induced force using the electrode;
(c) immobilizing the at least one particle on a surface of the electrode with an electrostatic force; and
(d) withdrawing the electrode from the liquid.

22. The method of claim 21, wherein there is a capillary force between the liquid and the electrode that is at least partially coated with the positively charged coating, wherein the capillary force between the liquid and the electrode that is at least partially coated with the positively charged coating is less than a capillary force between the liquid and an electrode that is not at least partially coated with a positively charged coating.

23. The method of claim 21, wherein the at least one particle comprises different types of particles, and wherein at least one type of particle is more uniformly attracted toward the electrode that is at least partially coated with the positively charged coating than an electrode that is not at least partially coated with the positively charged coating.

24. The method of claim 21, further comprising
(e) evaporating remaining liquid on the electrode with capillary action; and
(f) detecting the at least one particle on the electrode.
